(19) United States
(12) Patent Application Publication
(10) Pub. No.: US 2017/0308863 A1
(43) Pub. Date: Oct. 26, 2017

(54) PUBLIC EMPLOYMENT TRACKING SYSTEM (PETS)

(71) Applicant: Chet M. Pitts, Detroit, MI (US)

(72) Inventor: Chet M. Pitts, Detroit, MI (US)

(21) Appl. No.: 15/494,446

(22) Filed: Apr. 21, 2017

Related U.S. Application Data
(60) Provisional application No. 62/325,611, filed on Apr. 21, 2016.

(51) Int. Cl. G06Q 10/10

(52) U.S. Cl. CPC G06Q 10/1053

(57) ABSTRACT

This invention relates to a computerized process and system for matching job seekers to employers. The computerized process and system are adapted to a government-sponsored employment-program setting where participants receive benefits, public assistance or compensation contingent on participating in a job-placement process. More specifically, the invention relates to a computer-implemented job-placement process and system that matches job seekers to employers while monitoring the activity and results of participating job seekers, employment-agency personnel, and employers (collectively, “participants”) to determine (1) whether employment agencies are providing satisfactory service levels to job seekers and employers, and (2) whether any participant is misusing or defrauding the system to create the appearance of a job search or job-placement activity in order to secure benefits, assistance, or compensation that are contingent upon participation.

### FIELD OF INVENTION

This invention relates to a computerized process and system for matching job seekers to employers. The computerized process and system are adapted to a government-sponsored employment-program setting where participants receive benefits, public assistance or compensation contingent on participating in a job-placement process. More specifically, the invention relates to a computer-implemented job-placement process and system that matches job seekers to employers while monitoring the activity and results of participating job seekers, employment-agency personnel, and employers (collectively, “participants”) to determine (1) whether employment agencies are providing satisfactory service levels to job seekers and employers, and (2) whether any participant is misusing or defrauding the system to create the appearance of a job search or job-placement activity in order to secure benefits, assistance, or compensation that are contingent upon participation.

### BACKGROUND OF THE INVENTION

The statements in this section merely provide background information related to the present invention and are not intended to constitute an admission of prior art.

Numerous employment websites exist for the purpose of connecting job seekers and employers. These websites enable job seekers to perform functions related to seeking employment and enable employers to perform functions related to seeking employees. For example, a job seeker can search job postings, upload a resume, apply for one or more positions, and monitor the status of job applications. An employer can post job openings, identify candidates for job openings, set up interviews, and communicate with job seekers.

However, for a variety of reasons, the job seeker may not find a job quickly or at all and may remain unemployed or under-employed. An employer posting a job opening is interested only in filling the job. Once the job is filled, the employer is done with the process. In commercial job-placement settings, there is little interest or attention to tracking outcomes for job seekers who do not qualify for an opening or who are not selected for employment.

In contrast, in government-sponsored job-placement programs, one or more third parties are often involved in the job-placement process as facilitators and advocates. Such third parties are often government departments, agencies, programs, or contractors (collectively, “workforce-development agencies”) and their employees. Such workforce-development agencies are often compensated or evaluated on the basis of job-placement success rates.

Also in such government-sponsored job-placement settings, job seekers are often incentivized to participate in the process because other benefits or assistance are contingent on on-going participation in job-seeking activity.

The Public Employment Tracking System (“PETS”) is a web-based platform for managing job searches and job placement for job seekers and employers with the involvement of workforce-development agencies and personnel. PETS matches job-seeker profiles and resumes with employer job descriptions to identify a pool of suitable jobs for a job seeker and a pool of suitable job seekers for a particular job opening. PETS comprises a computer-implemented software system programmed to (a) monitor job-seeking activity; (b) track the progress and status of a job seeker through the job-placement process; (c) display tracked progress and status to workforce-development agency personnel, namely, case managers and/or job developers; (d) identify job seekers needing assistance in the job-search process; (e) provide a means for messaging between job seekers, employers, case managers, and job developers; (f) create reports summarizing job-placement progress and status; and (g) detect potential misconduct or fraud during the job-placement process.

Various systems have been developed to assist job seekers and employers to identify and contact each other, for instance, the system disclosed in U.S. Pat. No. 9,449,300 B2, a multiple-employer city-government jobs-posting system that enables city governments to post and manage job announcements and allows prospective employees to prepare and save electronic resumes and to submit the electronic resumes to the city governments in response to the prospective job announcements. The system allows prospective employees to search for posted job announcements and allows city governments to search electronic resumes and to contact the prospective employees.

Existing job-placement websites and systems do not provide adequate controls in job-placement scenarios where participants receive benefits, assistance, or compensation for participating. Existing job-placement websites and systems do not adequately accommodate the involvement of case managers and job developers and do not provide a means for analyzing or auditing the activity and results of system participants. In particular, existing systems do not provide an adequate means of identifying, monitoring and highlighting the existence of fraud factors in government-sponsored job-placement settings.

It is an objective of PETS to provide a computerized job-placement process and system that is adapted to the special requirements of government-sponsored job-placement programs and that solves the aforementioned deficiencies. It is an objective of PETS to integrate case managers and job developers into the job-placement process by means of a computerized system that enables accurate, timely tracking and reporting of job-seeker progress and status. It is an objective of PETS to identify, monitor, analyze, and report on factors indicating potential fraud, such as failure to follow-through on suitable job opportunities or job candidates, or the misreporting of job-placement success rates. By monitoring and highlighting the existence of fraud factors, PETS can control and minimize waste, fraud, or ineffectiveness in government-sponsored job-placement settings. Fraud factors include (1) a job seeker applying for an excessive number of jobs for which the job seeker is not qualified, (2) a job seeker failing to apply for an excessive number of jobs for which the job seeker is qualified, (3) a potential employer failing to follow through on a threshold number of job postings despite the availability of qualified candidates, and (4) a workforce-development agency (“job agency”) misreporting job-placement success rates, and (5) a job agency applying for an excessive number of job openings on behalf of unqualified job seekers.

While some of the objectives and features of the present invention are disclosed in prior art, no prior art known to the applicant includes all of the objectives and features provided by PETS, which address and solve existing problems in the government-sponsored job-placement settings.

### SUMMARY OF THE INVENTION

The present invention addresses the deficiencies of pre-existing job-placement systems in government-sponsored job-placement settings and satisfies the objectives described above.

### DESCRIPTION OF THE VIEWS

The drawings and views illustrate certain aspects of exemplary embodiments of the invention and are intended to explain the invention without limiting its scope.

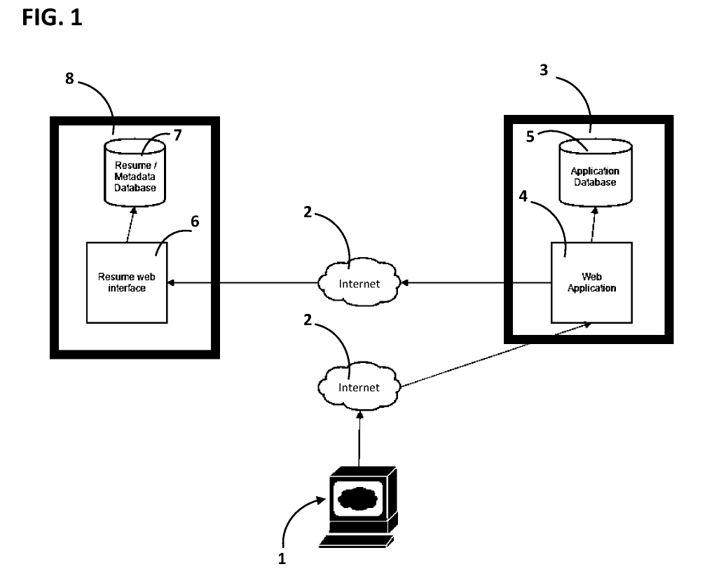

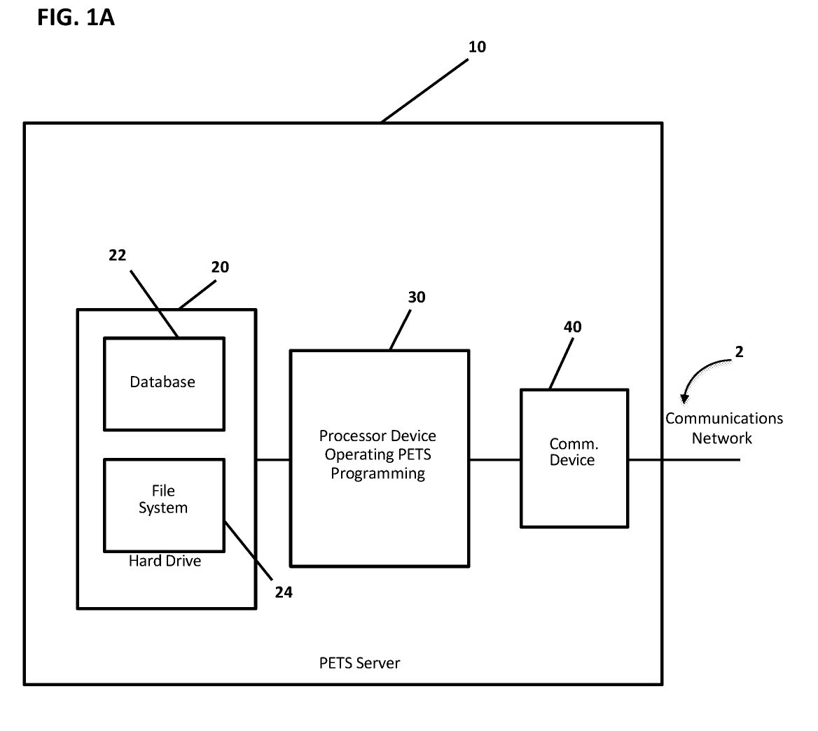

FIG. 1 is a schematic view of an exemplary embodiment of PETS depicting a user-interface device 1, a first server device 3, a second server device 8, and a wide-area network 2, wherein said first server device 3 hosts a web application 4 and an application database 5, and said second server device 8 hosts a resume web-interface application 6 and a metadata database 7;

FIG. 1A is a schematic, drill-down view of the hardware and software components of said first server device and said second server device from FIG. 1; FIG. 1A depicts an exemplary server device 10, a processor 30, a hard drive 20 which holds a filesystem 24 and a database 22, and communications module 40, and their internal bus connectors and external network connectors;

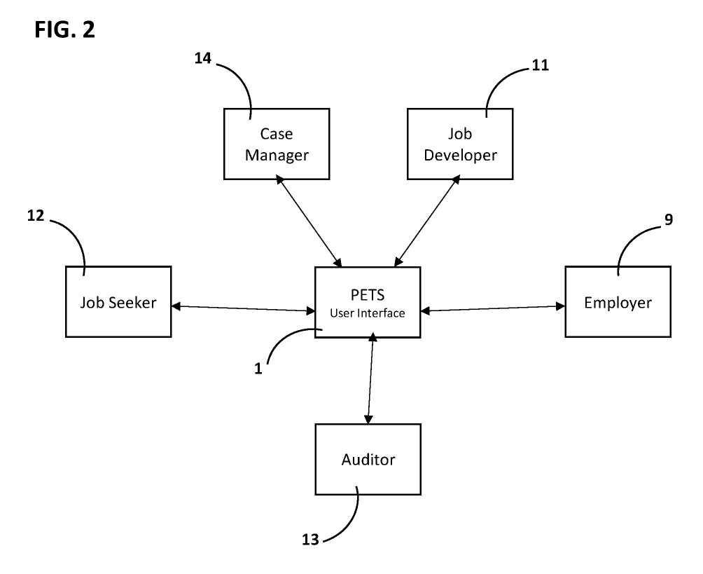

FIG. 2 is a schematic view of the types of users (or “participants”) who interact with the system, namely, job seekers 12, case managers 14, job developers 11, employers (or “companies”) 9, and auditors (or “administrators”) 13, as well as their point of interface with the system, namely, a user-interface device 1, such as a PC, laptop computer, or tablet computer;

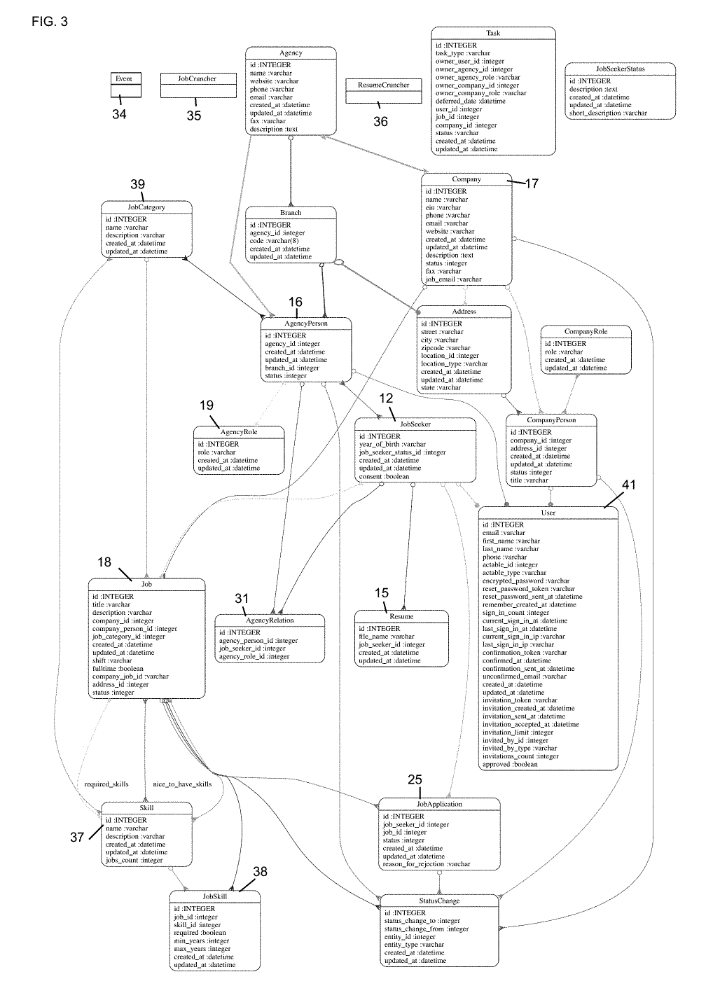

FIG. 3 is an entity-relationship diagram showing the attributes of the entities that comprise the system and the relationships between said entities;

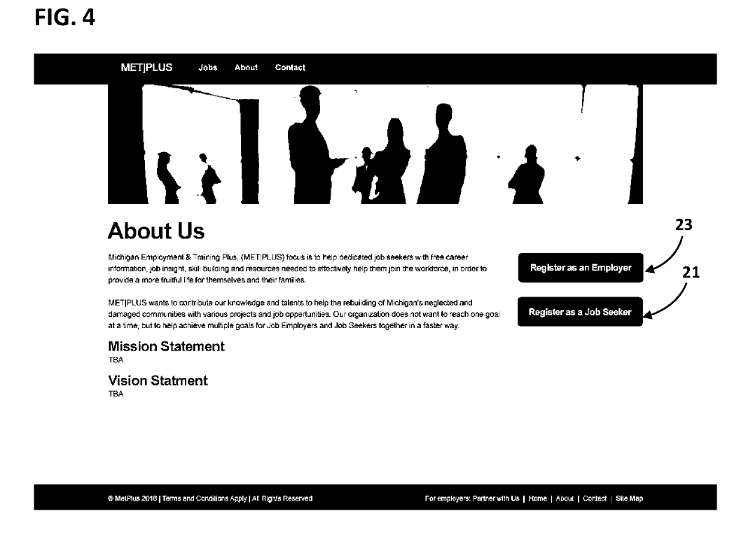

FIG. 4 is a mock-up of an “About Us” page that forms part of an exemplary PETS user interface that offers job seekers and employers a means to register to use the system;

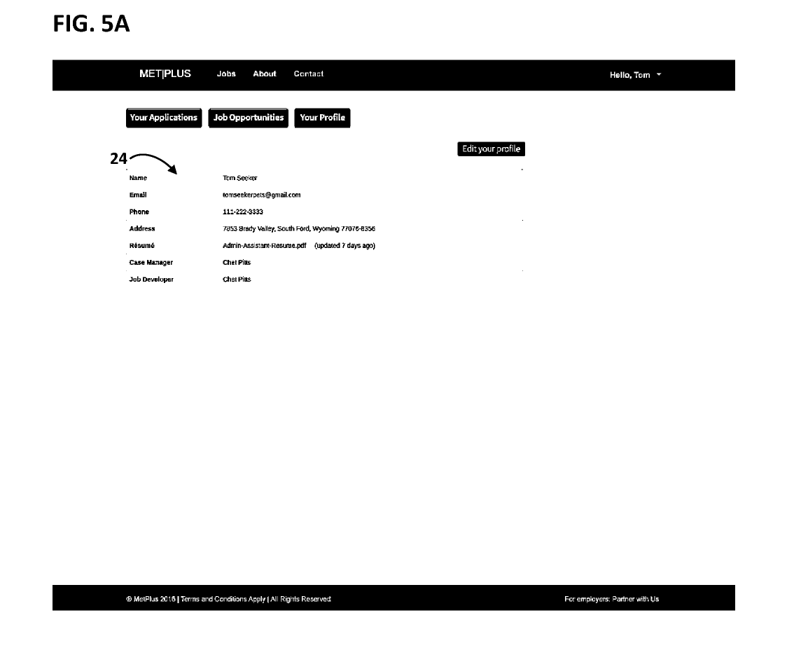

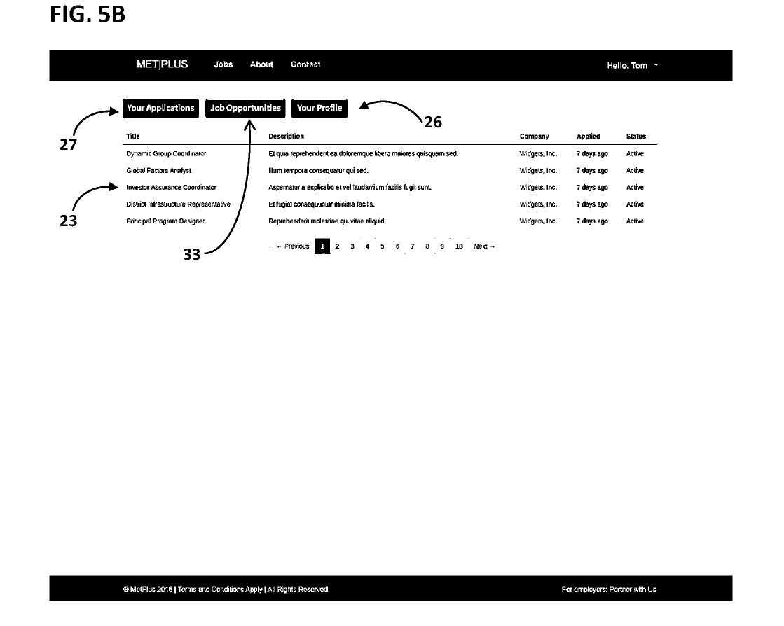

FIG. 5A is a mock-up of a page that forms part of an exemplary PETS user interface and offers a job seeker a means to create or update his or her profile;

FIG. 5B is a mock-up of additional tabs of the page depicted in FIG. 5A that form part of said exemplary PETS user interface that offer a job seeker means to view job opportunities 33 or his or her job applications 27; FIG. 5A further depicts a list of job seeker's job applications 23;

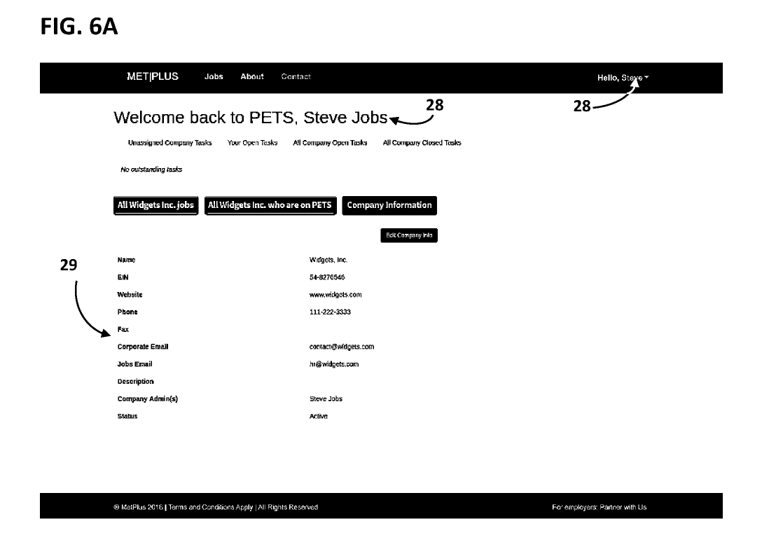

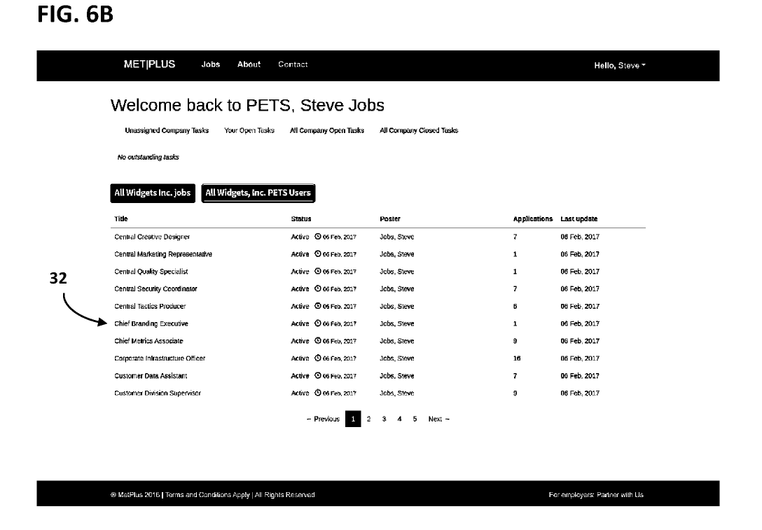

FIG. 6A is a mock-up of a page that forms part of an exemplary PETS user interface that enables an employer (or its representative) 28 to create or update the employer's profile 29;

FIG. 6B is a mock-up an additional tab of the page depicted in FIG. 6A that forms part of said exemplary PETS user interface that enables an employer to view its job openings 32;

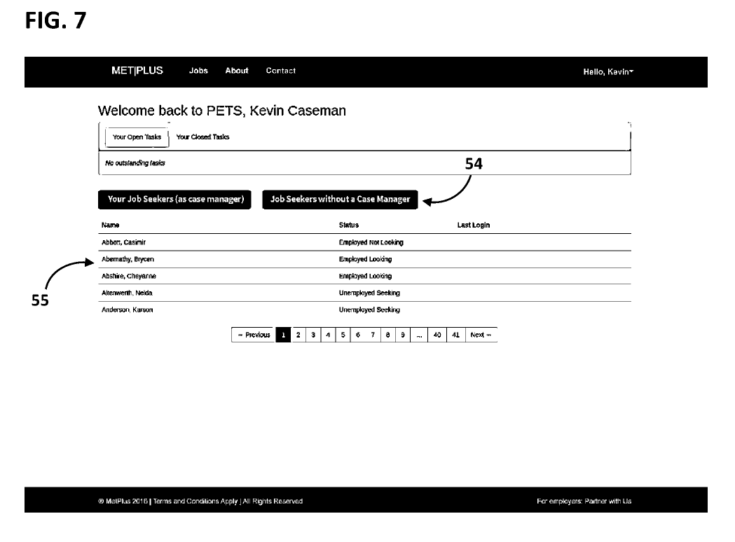

FIG. 7 is a mock-up of a page that forms part of an exemplary PETS user interface that enables a case manager to view (a) job seekers who are not yet assigned to a case manager 54 and (b) job seekers already assigned to said case manager 55;

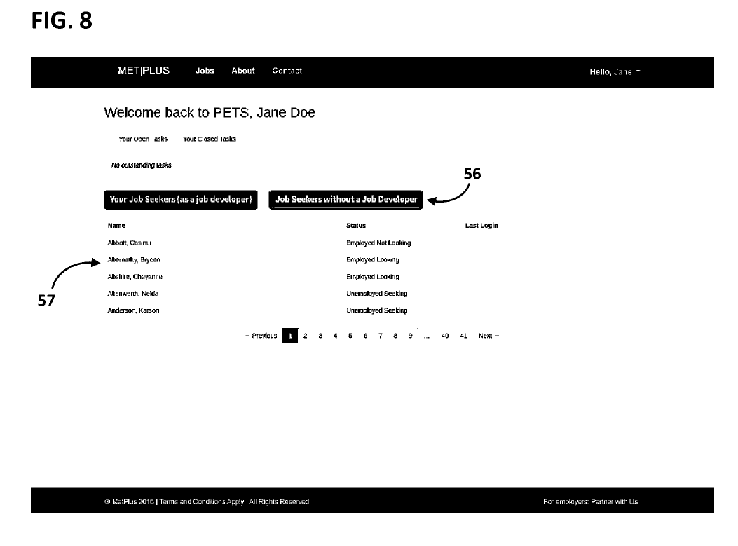

FIG. 8 is a mock-up of a page that forms part of an exemplary PETS user interface that enables a job developer to view (a) job seekers who are not yet assigned to a job developer 56 and (b) job seekers already assigned to said job developer 57;

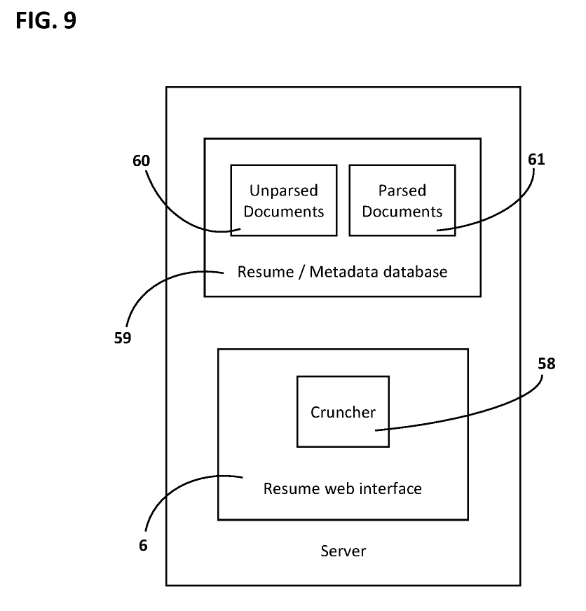

FIG. 9 is a schematic, drill-down view of the software components of said second server device from FIG. 1A; FIG. 9 depicts (a) a document-parser (“cruncher”) software module 58 that is part of the resume web interface 6 and (b) unparsed documents 60 and parsed documents 61 that are stored within the metadata database 59;

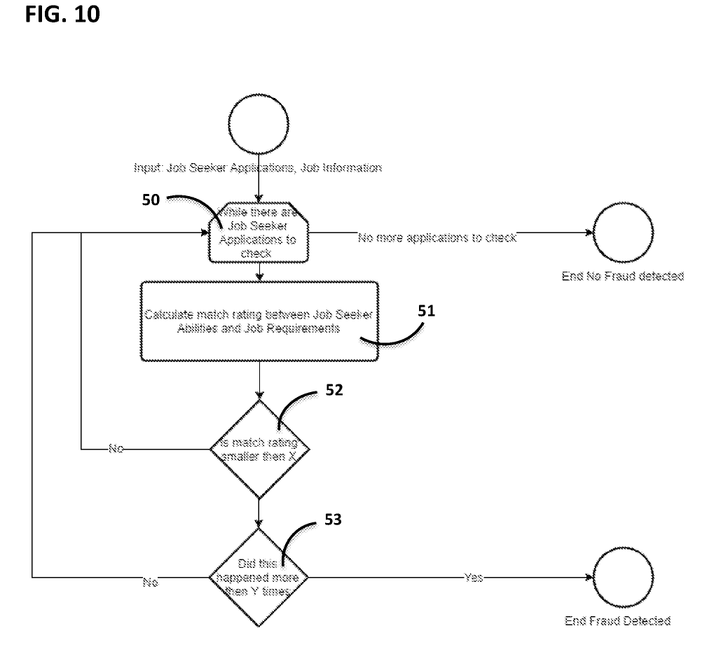

FIG. 10 is a flowchart depicting the sequence of operations in a job-seeker fraud-detection process and software module;

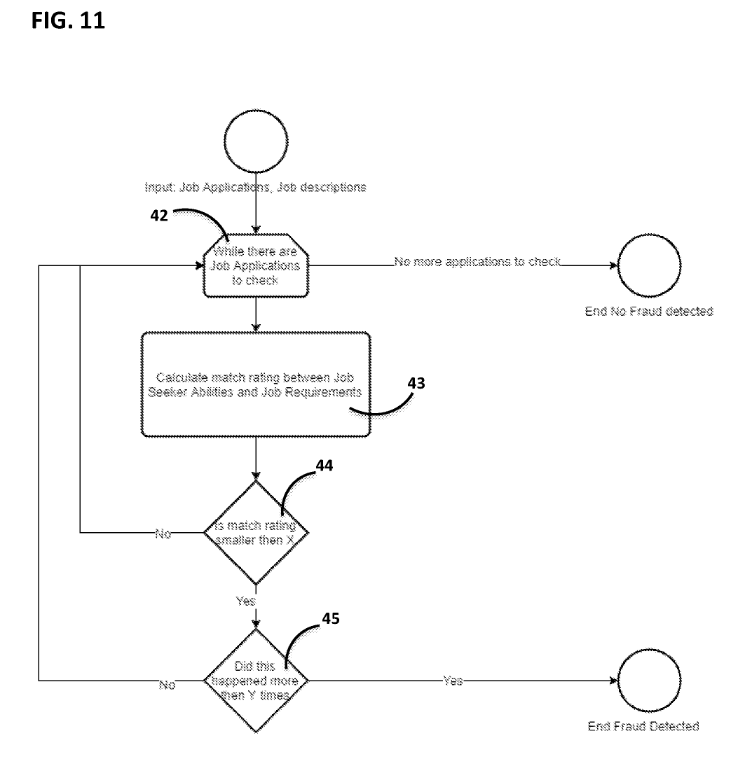

FIG. 11 is a flowchart depicting the sequence of operations in a process and software module that detects potential fraud by job developers, case managers, and job agencies; and

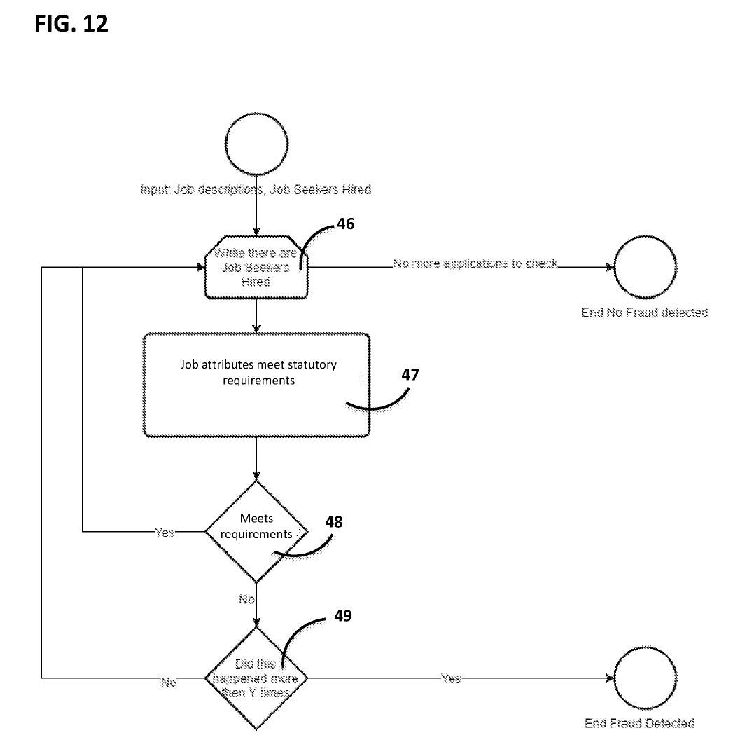

FIG. 12 is a flowchart depicting the sequence of operations of an employer fraud-detection process and software module.

### DETAILED DESCRIPTION OF THE INVENTION

Certain embodiments and variants will now be described by way of example, with reference to the accompanying drawings and views.

The invention is a computerized process and system for coordinating, overseeing, and auditing a job-placement process involving job seekers, employers, and facilitators. The system can be described as a public employment tracking system (“PETS” or the “system”).

In one embodiment, as illustrated in FIG. 1, the system is comprised of a user-interface device 1, a web application 4 and an application database 5 which are hosted on a first server 3, a resume web interface 6 and a metadata database 7 which are hosted on a second server 8. The user-interface device, the first server and the second server are connected by way of a wide-area network 2, such as the internet, a publically-accessible, TCP/IP-based, physical network. The user-interface device can be a PC, laptop, or tablet computer having a physical or software-implemented keyboard for entering data. The web application manages all the interactions between system users, identified below.

FIG. 1A further illustrates the configuration of the two server devices depicted in FIG. 1. Each such server device is equipped with the necessary components to operate the computerized processes and applications disclosed herein. An exemplary PETS server 10 is depicted. Each PETS server (of which there are two, as shown in FIG. 1) comprises a hard drive 20, a processor device 30, and a communications device 40. Each server contains an electro-mechanical or solid-state electronic storage device (a “hard drive”) 20, which holds (a) an industry-standard filesystem 24, such as a Linux ext4 filesystem, and (b) a database 22, such as an industry-standard relational database, such as PostgreSQL, or an industry-standard NoSQL document database, such as MongoDB. The PETS executables are read from the filesystem by the processor device and then executed. The processor device interacts with the filesystem, the database, and other servers and user-interface devices by way of the communications device installed in the server, such as an Ethernet network card, which provides access to a wide-area network 2, such as the internet. The web application, which runs on the first PETS server device, and the resume web interface, which runs on the second PETS server device, exchange information and make service calls to one another by way of an industry-standard REST API over an industry-standard SSL connection, which uses the internet-standard TCP/IP network protocol. The processor device is configured to run a plurality of PETS programming routines and modules that perform computerized functions such as receiving input, making a determination based upon the input, and sending output to a system user or administrator. The PETS programming routines and modules include programming that enable a job seeker to (a) register, (b) upload resumes, (c) query and display available job postings, and (d) enable job seekers to apply for job postings. The PETS programming routines and modules also include programming to enable an employer to (a) post job openings, (b) search for job seekers, and (c) facilitate interviews and messaging between job seekers and employers.

The PETS programming routines and modules also include programming to (a) monitor job seekers progress, (b) flag and take action when job seekers or other system users meet threshold failure criteria in the employment process, (c) monitor job postings, and (d) flag and take action when companies hire job seekers for positions that fail to meet regulatory requirements. The disclosed database 22 facilitates tracking of job seekers as they go through the job-search process. If a job seeker is rejected by a company, the system records the rejection to assist job developers with placing the job seeker in a more suitable job in the future.

In one embodiment, as illustrated in FIG. 2, the system involves five types of users (or “participants”): A “job seeker” 12 is a person who is searching for a job. A “case manager” 14 is a staff person of an employment program, agency, or company who is responsible for assisting job seekers in finding employment. A “job developer” 11 is also a staff person of an employment program, agency, or company who is responsible for assisting employers in finding employees. An “employer” 9 is a staff person of a company that seeks employees who posts jobs and reviews job seeker applications. An “auditor” 13 (or alternatively, an “administrator”) is a person who verifies that the other participants are properly fulfilling their duties with respect to a job-placement process.

In one embodiment, as illustrated in FIG. 3, the system has an application database that stores the entities and maintains the relationships between said entities required to support the system. In particular, a job seeker 12 is a type of user 41. A job seeker may have one or more resumes 15 and may be associated with one or more agency persons 16. Each agency person 16 is also a type of user 41 and may serve in one or more agency roles 19, namely, “case manager” and/or “job developer.”

In one embodiment, as illustrated in FIG. 4, an employer or a job seeker may register with the system by clicking on a hyperlinked button corresponding to the registrant's role, namely, employer 23 or job seeker 21.

In one embodiment, as illustrated in FIG. 5A, a job seeker may create or edit a profile 24 composed of name, email, phone, address, one or more resumes, and (optionally) a case manager and/or a job developer by entering and uploading said profile components by way of a user-interface device 1 as shown in FIG. 1. Resumes must be uploaded in searchable, electronic form, such as Microsoft Word format or searchable PDF. Upon uploading a resume, the system inserts the file name of each resume in the resume table 15 in the application database as shown in FIG. 3. The system stores the resume itself by copying the electronic document from the user-interface device 1 as shown in FIG. 1 into (a) a designated directory (or “folder”) in the filesystem on the hard drive of server 8 as shown in FIG. 1 and FIG. 1A or, in a variant embodiment (b) a document database on the hard drive of server 8 as shown in FIG. 1 and FIG. 1A.

In one embodiment, as illustrated in FIG. 6A, a representative of an employer 28 may create or edit company information 29 composed of name, EIN, website, phone, fax, corporate email, jobs email, company description, one or more company administrators, and a status code by entering said information via a user-interface device 1 as depicted in FIG. 1. Upon creating or editing said information, the system inserts or updates the corresponding record in the company table 17 of the application database as shown in FIG. 3.

In one embodiment, as illustrated in FIG. 6B, a Company may post a job opportunity 32 by entering the job title, status, poster, description, and required skills via a form-based web interface. Upon submitting said job information to the system, such as via clicking a hyperlinked “Submit” button which causes the user interface to send an HTTP POST request to the system, which in turn causes the system to execute an SQL statement to insert said information in the job table 18 of the application database as shown in FIG. 3.

In one embodiment, as illustrated in FIG. 5B, a job seeker may search for job opportunities that match his or her profile and resume by clicking on a hyperlinked button 33 which causes the user interface to send an HTTP GET request to the system, which in turn causes the system to execute an SQL query to retrieve a list of job postings sorted in descending order by “match ratio” in relation to the job seeker's resume. (The “match ratio” matching process is described in more detail herein below.) The job seeker can apply for a listed job opportunity by clicking on a hyperlink corresponding to the desired job opportunity, which sends an HTTP POST request to the web application, which in turn inserts a record into the job application table 25 of the application database as shown in FIG. 3. A job seeker may list job opportunities for which he or she has applied by clicking on a hyperlinked button 27 which causes the user interface to send an HTTP GET request to the system, which in turn causes the system to execute an SQL query to retrieve a list of job applications 23 from the job application table. A job seeker may display his or her profile by clicking on a hyperlinked button 26 which causes the user interface to send an HTTP GET request to the system, which in turn causes the system to execute an SQL query to retrieve records from the user table 41, the resume table 15, and the job seeker table 12 that are associated with the job seeker's unique system ID.

In one embodiment, as illustrated in FIG. 7, a case manager may query the application database by clicking a form-based hyperlinked button 54 that causes the web application to execute a stored SQL statement against the application database to retrieve a list of job seekers not yet assigned to a case manager. Said query performs an outer join of the job seeker table 12, the agency relation table 31, the agency person table 16, and the agency role table 19 in the application database as shown in FIG. 3 and returns a list 55, as shown in FIG. 7, of all job seekers not associated with a case manager role. A case manager may assign a job seeker to the case manager's case load by clicking a hyperlinked button corresponding with the job seeker which sends an HTTP POST request to the web application, which in turn inserts a record into the agency relation table 31 as shown in FIG. 3.

In one embodiment, as illustrated in FIG. 8, a job developer may query the application database by clicking a form-based hyperlinked button 56 that causes the web application to execute a stored SQL statement against the application database to retrieve a list of job seekers not yet assigned to a job developer. Said query performs an outer join of the job seeker table 12, the agency relation table 31, the agency person table 16, and the agency role table 19 in the application database as shown in FIG. 3 and returns a list 57, as shown in FIG. 8, of all job seekers not associated with a job developer. A job developer may assign a job seeker to the job developer's case load by clicking a hyperlinked button corresponding with the job seeker which sends an HTTP POST request to the web application, which in turn inserts a record into the agency relation table 31 as shown in FIG. 3.

In one embodiment, case managers and job developers can review the entire pool of job seekers from one paginated screen and see a color-coded status for each job seeker. In one embodiment, red highlight means that a job seeker has been rejected, green highlight means that a job seeker is hired, and yellow highlight means that a job seeker has applied but not yet been rejected or hired. Case managers and job developers use the status of job seekers to provide individualized attention ensuring that no job seeker is lost or ignored in the job-placement process.

In one embodiment, as illustrated in FIG. 1, when a resume is uploaded into the system by a job seeker using a user-interface device, the web application passes the resume via the network to the resume web interface. As illustrated in FIG. 9, the resume web interface 6 parses a resume by passing the unparsed resume to a cruncher module 58. As mentioned, resumes must be uploaded in a searchable format, such as searchable PDF or Microsoft Word format. The cruncher catalogs and counts all words that occur in a resume using industry-standard Java Natural Language processing libraries. The unparsed form of a resume 60 and parsed form of a resume 61 are stored in the metadata database 59. The parsed form of a resume is stored in industry-standard JSON or XML structure comprised of a document identifier and an ordered array (the “top-level array”) of two-element subarrays, with each subarray consisting of a character string (a word) and a positive integer (the word count); the elements of the top-level array are ordered by word count, from largest to smallest, to aid in comparison with other documents such as job descriptions.

In one embodiment, as illustrated in FIG. 1, when a job posting is entered into the system by an employer using a user-interface device, the web application passes the job description via the network to the resume web interface. As illustrated in FIG. 9, the resume web interface parses a job description by passing the unparsed description to the cruncher module. Job descriptions must be entered in text format. The cruncher catalogs and counts all words that occur in a job description using industry-standard Java Natural Language processing libraries. The unparsed form of a job description 60 and parsed form of a job description 61 are stored in the metadata database 59. The parsed form of a job description is stored in an industry-standard JSON or XML structure comprised of a document identifier and ordered array (the “top-level array”) of two-element subarrays, with each subarray consisting of a character string (a word) and a positive integer (the word count); the elements of the top-level array are ordered by word count, from largest to smallest, to aid in comparison with other documents such as resumes.

In one embodiment, the system compares the parsed form of a resume with the parsed form of a job description by calculating the “matching ratio” of (a) the number of word occurrences in common and (b) the total number of words in the job description. Said matching ratio can be used to rank job seekers in relation to a given job description, or job postings in respect to a given job seeker.

In one embodiment, a job seeker (or a case manager or job developer on a job seeker's behalf) may browse job opportunities in the system by clicking on a hyperlinked “job opportunities” button 33 as shown in FIG. 5B. Upon clicking said button, the interface sends an HTTP POST request to the web application. The web application then executes a stored SQL statement against the application database to retrieve a list of all job opportunities sorted in descending order by suitability. Suitability is determined by the matching ratios produced by comparing the job seeker's resume to each job description using the cruncher module of the resume web interface as depicted in FIG. 9. In one embodiment, the title of each job is displayed in the form hyperlinked text.

A job seeker may apply for a listed job by clicking on the hyperlinked job title or a corresponding “Apply” button, upon which the system inserts a record into the job application table 25 of the application database as shown in FIG. 3.

In one embodiment, a job seeker (or a case manager or job developer on a job seeker's behalf) may browse job opportunities in the system by selecting one or more filter criteria, such as job title, employer, location, description, job requirements, or a combination thereof using a form-based web interface. The form-based interface is displayed on the screen of the user-interface device 1 as shown in FIG. 1. Upon clicking a hyperlinked “Submit” button on said form-based interface, the user interface sends an HTTP POST request to the web application. The web application builds a standard SQL statement by adding the selected filter criteria to the WHERE clause of said SQL statement, then executes said SQL statement against the application database to retrieve a list of matching job opportunities. The title of each job may be displayed in the form hyperlinked text. A job seeker may apply for a listed job by clicking on the hyperlinked job title or on a corresponding “Apply” button, upon which the system inserts a record into the job application table 25 of the application database as shown in FIG. 3.

In one embodiment, as depicted in FIG. 3, the system maintains an event log 34 of all activity on the system, including logins, profile creations, profile updates, job postings, job searches, job applications, messages, responsive messages, interview requests, and job offers. The log is maintained in the event table 34 of the application database as depicted in FIG. 1 and FIG. 3. The system logs all participant interaction with the system and with other participants, as well as the time, date, and type of such interactions by executing an SQL INSERT statement into the event table (or “event log”) upon the occurrence of any such event.

A case manager, job developer, or administrator may use the system to review the activity of job seekers or other system users by querying the event log via a form-based web interface that permits the reviewer to select filter criteria from one or more industry-standard HTML drop-down lists. The system converts the form-based filter criteria into an SQL query and executes it against the event log, returning the resulting records to the user interface in a formatted result set, for example, an HTML table.

When a job seeker is inactive for a period of time exceeding a configurable threshold set in the application database, the system so notifies the case manager and the job developer who are assigned to that job seeker. Said notification is accomplished by means of a periodically executed background job, such as a Unix cron job, which executes a query against the event log, then sends a notification message, such as by e-mail or SMS, to the assigned case manager and job developer for any job seeker who has not logged any activity on the system within the configured threshold.

After a new job is posted to the system, a job developer, case manager, or employer may use the system to retrieve an ordered list of suitable candidates (“job seekers”) for said new job. Relative suitability of job seekers is determined by the matching ratios produced by comparing the job seeker's resume to the job description. Said matching ratios are calculated using the cruncher module of the resume web interface as depicted in FIG. 9. In one variant, the name of each job seeker in the ordered list may be displayed in the form hyperlinked text. An employer may elect to message a job seeker by clicking on the hyperlinked name or on a corresponding “Connect” button, upon which the system formulates and sends a message by way of a standard messaging interface, such as e-mail or SMS.

An auditor (or “administrator”) may query the system to determine whether other system participants are using the system and performing their job-search, job-placement, job-posting, or hiring functions in accordance with external criteria that may be a basis for participant compensation, benefits, or assistance. The system enables an auditor to issue an HTTP POST request via a form-based interface on the user-interface device to the web application. The POST request causes the web application to execute a stored SQL query that retrieves an ordered list from the event log of job seekers whose activity on the system in the form of logins, profile updates, job searches, or job applications is less than configurable thresholds or shows a pattern of anomaly suggestive of fraud, such as an excessive number of job applications for jobs for which a job seeker is not qualified coupled with the contemporaneous existence of other job openings for which the job seeker is better qualified.

The system enables auditors, job developers, and case managers to track job-seeker status, success, and failure by logging all job applications and all job-application acceptances and rejections in the event log. correlating job seekers to employer acceptances and rejections by way of an SQL or programmatic join of event log with itself by which records of the log table may be associated with each other on the basis of a job application ID to correlate job seekers to acceptances and rejections and to derive a count for each. The system aggregates counts of job-seeker acceptances and rejections in the event log by job seeker, by job developer, and by case manager by way of SQL “group by” clauses, producing a total success and failure rate for each job developer and case manager. In the same way, the system further aggregates job-seeker acceptances and rejections by job agency, summing over the set of job developers and case managers associated with a particular job agency. Using the foregoing aggregate counts, the system produces ratios of success for each job seeker, job developer, case manager, and job agency by dividing total successes by the combined total of all successes and failure for each participant and agency. The system further analyzes the event log for the purpose of fraud detection by breaking down the foregoing aggregates and ratios on the basis of (a) job applications that the job seeker was qualified for and (b) job applications that the job seeker was not qualified for, based in both cases on a matching-ratio comparison of the job seeker's resumes with the jobs applied for.

The system identifies a pattern of potentially fraudulent activity by a job seeker as illustrated in FIG. 10. In step 50 the web application fetches a list of job applications from the application database, ordered by job seeker, then evaluates each according to the flowchart in FIG. 10. In FIG. 10, “X” as used in step 40 represents a configurable number that is the minimum match rating not considered excessively low, and “Y” as used in step 52 represents a configurable number that is the maximum number of times a matching ratio (or “match rating”) can be less than X and not be considered fraudulent. For each application for a particular job seeker, the system retrieves the match rating from the resume web interface as depicted in FIG. 1 by way of an appropriate REST API. In step 51 the resume web interface calculates the match rating as described herein above by comparing words and word counts in the job seeker's resume to the job description. If the total count of applications having a low match rating exceeds a configurable threshold, such as 5 per month, the system alerts an auditor, such as via an e-mail or SMS message. Pseudo-code that implements the job-seeker fraud-detection functionality follows:
function is_job_seekers_committing_fraud(js_job_applications) BEGIN
   count_low_matching_rate=0
   FOR application IN js_job_applications DO
      js=application.js
      job=application.job
      match_rating=calculate_match_rating(js.resume, job.description)
      IF match_rating<MINIMUM_TO_BE_CONSIDERED_FRAUD THEN
         count_low_matching_rate+=1
         IF count_low_matching_rate==MAX_COUNT_OF_FRAUD_RATING THEN
         return TRUE
         END
      END
   END
   return FALSE
END;

The system identifies a pattern of potentially fraudulent activity by a case manager or job developer, or by a job agency that employs multiple case managers or job developers, as illustrated in FIG. 11. In step 42, the web application fetches a list of job applications from the application database, ordered by agency, then evaluates each according to the flowchart in FIG. 11. In FIG. 11, “X” as used in step 44 represents a configurable number that is the minimum match rating not considered to be excessively low, and “Y” as used in step 45 represents a configurable number that is the maximum number of times a match rating can be less than X and not be considered fraudulent. For each application for a particular agency, the system in step 43 retrieves the match rating from the resume web interface as depicted in FIG. 1 via an appropriate REST API call. The cruncher module of the resume web interface calculates the match rating as described herein above by comparing the words and word counts of the job seeker's resume to the job description. If the total count of applications having a low match rating exceeds a configurable threshold, such as 5 per month, the system alerts an auditor, such as by way of an e-mail or SMS message. Pseudo-code that implements the agency fraud-detection functionality follows:

The agency as a Whole is committing fraud
function is_agency_committing_fraud(agency_job_applications) BEGIN

count_low_matching_rate = 0
FOR application IN agency_job_applications DO

js = application.js
job = application.job
match_rating = calculate_match_rating(js.resume, job.description)
IF match_rating < MINIMUM_TO_BE_CONSIDERED_FRAUD THEN

count_low_matching_rate += 1
IF count_low_matching_rate == MAX_COUNT_OF_FRAUD_RATING THEN

return TRUE

END

END

END
return FALSE

END;
A Specific job developer is committing fraud
function is_job_developer_committing_fraud(job_developer_job_applications) BEGIN

count_low_matching_rate = 0
FOR application IN job_developer_job_applications DO

js = application.js
job = application.job
match_rating = calculate_match_rating(js.resume, job.description)
IF match_rating < MINIMUM_TO_BE_CONSIDERED_FRAUD THEN

count_low_matching_rate += 1
IF count_low_matching_rate == MAX_COUNT_OF_FRAUD_RATING THEN

return TRUE

END

END

END
return FALSE

END;

The system identifies a pattern of potentially fraudulent activity by an employer as illustrated in FIG. 12. In step 46 the web application fetches a list of accepted job applicants (“hires”) from the application database, ordered by employer, then in step 47 evaluates each according to the flowchart in FIG. 12, determining in step 48 whether the job attributes, such as pay rate, maximum hours, and overtime rate, satisfy applicable statutory requirements in the job seeker's jurisdiction and in the employer's jurisdiction. Said statutory requirements are stored in the application database with a searchable, character-string identifier, for example “minimum wage” coupled with a numerical component, such as a dollar amount. Such statutory compliance verifications are performed by retrieving a statutory requirement record from the application database, retrieving the corresponding job attribute from the application database, and performing an arithmetic comparison. In step 29 if the total count of hires failing to comply with a statutory requirement exceeds a configurable threshold, such as 1 per month, the system alerts an auditor, such as by way of an e-mail or SMS message. Pseudo-code that implements the agency fraud-detection functionality follows:

| | |
|---|---|
| function | is_company_commiting_fraud(company_hired_job_seekers_applications) |

BEGIN

count_not_in_compliance = 0
FOR application IN company_hired_job_seekers_applications DO

js = application.js
job = application.job
FOR requirement IN applicable_statutory_requirements DO

is_compliant = compare_job_attribute_to_requirement(job, requirement)
IF not is_compliant THEN

count_noncompliant += 1
IF count_noncompliant >= MAX_COUNT_OF_NONCOMLIANCE THEN

return TRUE

END

END

END

END
return FALSE

END;

The foregoing disclosure has described certain embodiments and variants of those embodiments. Further modifications and alterations may occur to others upon reading and understanding this specification. Therefore, it is intended that the disclosure not be limited to the particular embodiments disclosed as the best mode contemplated for carrying out this disclosure, but that the disclosure will include all embodiments falling within the scope of the appended claims.

What is claimed and desired to be secured by patent is as follows:

1. A computerized system for facilitating employment of a plurality of job seekers, the system comprising:
a. a computerized processor with programming configured to:
i. facilitate the job-seeking activity of each of a plurality of job seekers;
ii. monitor job seeking activity for each of the plurality of job seekers;
iii. automatically track progress of the job seekers through an employment seeking process; and
iv. display the tracked progress to a case manager or job developer who can assist the job seeker in the employment process.

2. The computerized system of claim 1, further comprising:
a. a computerized processor with programming configured to:
i. facilitate the job-seeking activity of each of a plurality of job seekers by enabling a job seeker to:
1. enter and maintain a profile and a plurality of resumes;
2. browse job openings on the basis of selected job attributes;
3. browse a list of job openings sorted in descending order of suitability for the job seeker based on an automated comparison of job descriptions with the job seeker's resume;
ii. facilitate the employee-seeking activity of each of a plurality of employers by enabling an employer to:
1. enter and maintain a profile and a plurality of job postings;
2. browse job seekers on the basis of selected job seeker attributes;
3. browse a list of job seekers sorted in descending order of suitability for a particular job opening based on an automated comparison of the job description with the job seekers' resumes.

3. The computerized system of claim 2, further comprising:
a. a computerized processor with programming configured to:
i. analyze the tracked progress of job seekers and the tracked activity of participants in an employment program, namely, employers, job developers, case managers, and job agencies, to determine whether a participant is misusing the employment program or defrauding the administrator of the employment program.

4. The computerized system of claim 3, further comprising:
a. a computerized processor with programming configured to:
i. analyze the tracked progress of job seekers and the tracked activity of participants in an employment program, namely, employers, job developers, case managers, and job agencies, to determine whether a participant is misusing the employment program or defrauding the administrator of the employment program.

5. The computerized system of claim 4, further comprising:
a. a computerized processor with programming configured to:
i. analyze the tracked progress of job seekers and the tracked activity of participants in an employment program, namely, employers, job developers, case managers, and job agencies, to determine whether a participant is misusing the employment program or defrauding the administrator of the employment program by:
1. performing an automated comparison of job applications and job openings to determine whether a job seeker, or a job developer or case manager or job agency on the job seeker's behalf, is applying for an excessive number of jobs for which the job seeker is not qualified even while job openings exist for which the job seeker is better qualified; and
2. performing an automated comparison of accepted job offers (“new hires”), job descriptions, and applicable law and regulations to determine whether an employer is in compliance with applicable requirements in relation to new hires;

6. A method for facilitating employment of a plurality of job seekers, the method comprising the steps of:
a. registering one or more job seekers;
b. registering one or more employers;
c. presenting an electronic interface by which a job seeker can enter a profile comprised of personal information;
d. presenting an electronic interface by which an employer can enter a profile comprised of descriptive information about the employer;
e. presenting an electronic interface by which an employer can post a job opening;
f. presenting an electronic interface by which a job seeker can browse job openings by job attribute;
g. presenting an electronic interface by which a job seeker can browse a list of job openings sorted in descending order of suitability for the job seeker based on an automated comparison of job descriptions with the job seeker's resume;
h. presenting an electronic interface by which an employer can browse job seekers by profile attribute;
i. presenting an electronic interface by which an employer can browse a list of job seekers sorted in descending order of suitability for a particular job opening based on an automated comparison of job descriptions with the job seeker's resume;
j. presenting an electronic interface by which a job developer or a case manager can facilitate the employment process by:
i. searching for and applying for jobs on behalf of a job seeker; and
ii. creating and editing profiles on behalf of a job seeker.

7. The method of claim 6, further comprising the steps of:
a. logging the activity of all participants in an employment program, namely job seekers, employers, job developers, case managers, and job agencies;
b. monitoring the activity for each of the plurality of job seekers;
c. displaying the tracked progress of a job seeker to a case manager or job developer who can assist the job seeker in the employment process.

8. The method of claim 7, further comprising the steps of:
a. logging the activity of all participants in an employment program, namely job seekers, employers, job developers, case managers, and job agencies;
b. monitoring the activity for each of the plurality of job seekers; and
c. displaying the tracked progress of a job seeker to a case manager or job developer who can assist the job seeker in the employment process.

9. The method of claim 8, further comprising the steps of:
a. analyzing the tracked progress of seekers and the tracked activity of participants in an employment program, namely, employers, job developers, case managers, and job agencies, to determine whether a participant is misusing the employment program or defrauding the administrator of the employment program.

10. The method of claim 9, further comprising the steps of:
a. analyzing the tracked progress of seekers and the tracked activity of participants in an employment program, namely, employers, job developers, case managers, and job agencies, to determine whether a participant is misusing the employment program or defrauding the administrator of the employment program by:
i. performing an automated comparison of job applications and job openings to determine whether a job seeker, or a job developer or case manager or job agency on the job seeker's behalf, is applying for an excessive number of jobs for which the job seeker is not qualified even while job openings exist for which the job seeker is better qualified; and
ii. performing an automated comparison of accepted job offers (“new hires”), job descriptions, and applicable law and regulations to determine whether an employer is in compliance with applicable requirements in relation to new hires.
